(19) United States
(12) Patent Application Publication
(10) Pub. No.: US 2008/0021763 A1
(43) Pub. Date: Jan. 24, 2008

(54) Method for incentivized collective perception assessment

(76) Inventor: Michael Merchant, Foothill Ranch, CA (US)

Correspondence Address: DALINA LAW GROUP, P.C., 7910 IVANHOE AVE. #325, LA JOLLA, CA, 92037, US

(21) Appl. No.: 11/483,272

(22) Filed: Jul. 6, 2006

(51) Int. Cl. G06F 17/30

(52) U.S. Cl. 705/10

(57) ABSTRACT

Methods for collecting accurate perception data points related to a given item from a set of respondents by offering an incentive that benefits the respondent or respondents who submit data points that match most closely to a calculated value of the data points collected. Provides methods for collecting perception data points by a market research service provider that offers considerably greater information and convenience to prospective initiators of market research service who desire to have a given item be assessed and offer the chances to win incentives to encourage accurate assessment and participation by respondents. Helps one to understand how others perceive the value of a given item so that one may make an educated judgment on how to price such item. The object of the invention is that the more accurate the perception data given by respondents, the more likely the respondents will win the incentive.

### BACKGROUND OF THE INVENTION

1. Field of the Invention

The present invention relates generally to market research service and more specifically to the methods and systems for collecting perception data points related to a given item from a set of respondents by offering an incentive that benefits the respondent or respondents who submit data points that match most closely to a calculated value of the data points collected.

2. Description of the Related Art

In general, market research plays an important role in understanding the wants, needs and behaviors of the market place, both in the current and future trends. Market research is often applied in business-to-business and business-to-consumer applications. The implementation of a market research program requires a significant amount of investment in money, time and resources. When someone requires a better understanding of the market place, they will obtain information using an in-house market research service, third party market research service, or both.

There is a need to simplify a complex, time-consuming and potentially expensive process of recruiting individuals or companies and assigning them to surveys. This is a long existing problem in all areas of market research. In an effort to increase participation and response rate by respondents, incentives consistently exert positive effect on response rates in surveys.

It may not be feasible to award each respondent with incentives as this method may make it very expensive to do a market research. One way to minimize the cost of incentives and encourage participation in surveys is to offer the chance to win prizes for the respondents. While response rates may be higher than survey methods with no incentive, there is a problem in that various survey methods with incentives may not get respondents interested in providing accurate perception data points. There is a need for a market research method that get respondents interested in providing accurate data points in surveys and awarding an incentive to those who submit data points that match most closely to a calculated value (e.g. average) of the data points collected.

Furthermore, there is a need for a market research service provider to give greater convenience and control for an initiator of the service over how much incentive to supply thus the cost of doing market research.

There are services that provide, for example, pricing reports of commodity items. Such services may lack flexibility in researching specialty items or providing accurate and up-to-date reports for a local market or dynamic industry. For example, a service like Kelly Blue Book may not be able to give an accurate pricing report for a specific model that has been individually modified, has a special attribute, or faces changing demand of a local market. It is generally accepted that local professionals in related industries (e.g., car dealership) will be more likely to give accurate perceived value of an item to be surveyed. There is a need for a service that offers considerably greater information and convenience to a prospective market research initiator who needs to obtain timely survey data that may take advantage of local or industry related knowledge.

### SUMMARY OF THE INVENTION

The present invention relates generally to methods for collecting accurate perception data points related to a given item from a set of respondents by offering an incentive that benefits the respondent or respondents who submit data points that match most closely to a calculated value of the data points collected.

It is one aspect of the invention to provide a method for collecting perception data points by a market research service provider that offers considerably greater information and convenience to prospective initiators of market research service who desire to have a given item be assessed and offer the chances to win incentives to encourage accurate assessment and participation by respondents. It is still another aspect of the invention to provide a method to help one to understand how others perceive the value of a given item so that one may make an educated judgment on how to price such item. The object of the invention is that the more accurate the perception data given by respondents, the more likely the respondents will win the incentive.

This methodology has many applications in market research, especially in establishing price points for new products, but there are many other fields which could benefit from this type of perception assessment such as financial analysis for synthesizing market predictions, or in human resources for setting job salaries.

Other objects, features and advantages of the present invention will become apparent to those skilled in the art from the detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications and equivalents thereof.

### DESCRIPTION OF THE FIGURES

The invention is illustrated by way of example, and not by way of limitation, in the figures of the accompanying drawings in which like reference numerals refer to similar elements and in which:

FIG. 1 is a flow diagram for the process of incentivized collective perception assessment of one embodiment in accordance with the invention.

FIG. 2 illustrates a flow diagram that illustrates a part of the process showing the logic of awarding incentive to respondent(s).

FIG. 3 is a diagram of a computer system context.

### DETAILED DESCRIPTION OF THE INVENTION

A method and system for incentivized collective perception assessment is described. In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in diagram form to avoid unnecessarily obscuring the present invention.

In this Specification and in the claims that follow, the terms recited below are associated with the following basic definitions:

Incentive: Any tangible or non-tangible benefit offered for participation in the process.

Initiator: Any entity or group of entities, living or non-living, which initiates the execution of the process.

Item: Any good, service or intangible that may be conveyed as stimulus to a respondent.

Network: One or more connections for enabling communication between or among users.

Perception: Singular data point or set of data points provided by a respondent and refers to the ability to analyze the item, objectively or subjectively, not necessarily cognitively, and provide a response.

Process: The invention that is the subject of this patent and described in the Specification.

Respondent: Any entity or group of entities, living or non-living, that participates in the process by providing a perception response. The respondent may participate in the process voluntary or by invitation.

Stimulus: Presentation of an item to respondent through any combination of physical, textual, visual, auditory, or electronic means.

Process

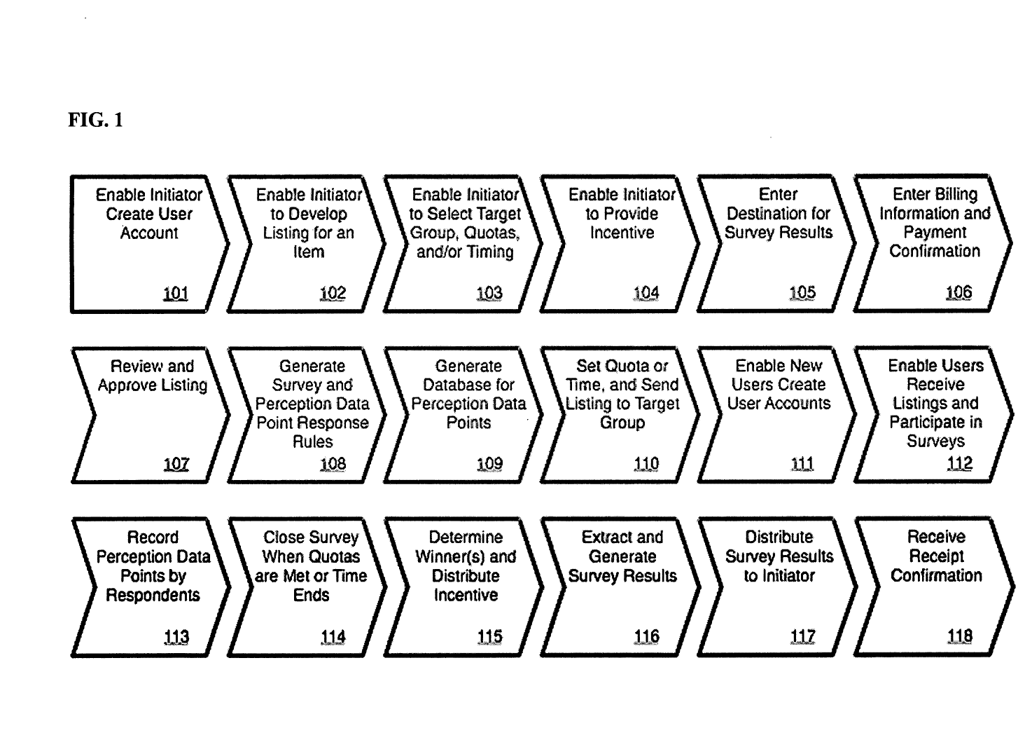

FIG. 1 illustrates one embodiment of the process of incentivized collective perception assessment. Meaningful survey results typically require perceptions from a non-biased population. In certain embodiments, user account mechanism during the process attempts to prohibit users from participating in a particular survey multiple times. Respondents should have no knowledge of others' perceptions and alerting them of a duplicate perception would give them some knowledge about the other's perception, thus mechanisms in the process attempts to limit respondents from accessing such knowledge. A survey could have one or more dimensions (e.g. price and favorability on a scale of 1 to 10). Each respondent will typically be allowed to submit one perception data point per dimension during one execution of the process, however, a variation of this process could allow for respondents to submit a given number of data points per dimension. Each user account with an associated user account identification is restricted to one response, in attempt to prevent respondents from exploiting the process to gain incentives, by linking the user account to one or more personal unique identifying information such as, for example, a physical postal address, bank account for receiving incentive, driver license number, social security number, or e-mail address.

A new user may enter the process at step 101 as initiator. A current user, in response to a need for some collective assessment of an item, may enter the process at step 102 as an initiator. A user account interface interacts with a new user to collect pertinent information about the user and stored in an information repository such as a database for user account. In certain embodiments, demographic data may be collected from the user during the steps 101 of creating a user account, and stored in the information repository for user account. The demographic data is collected from users pertaining personal information such as, for example, age, martial status, address, number and age of any children, occupation, annual income, etc. The process is executed by an initiator, or by a proxy at the request of the initiator, in response to a need for some collective assessment of an item. At the beginning of the process at step 101, an initiator interacts with an interface to set up an account with the market research service provider.

At the step 102, the initiator, or by a proxy at the request of the initiator, interacts with an interface to develop content for a survey of an item. When the initiator tries to create a survey for a common item, listing development interface may present an interactive template in which initiator may furnish description of the item, including, for example, image, odor, sound, taste, text, and texture. The interface with a common item template interacts with the initiator by using a generic form with descriptive entries for which respondents may use such information to evaluate the item and provide their perception. For example, if the item is a house, the interface brings up a real estate template which asks for pertinent information such as, for example, number of bedroom, number of bathroom, square footage, age of the house, picture of the house, map, location, etc. The interface provides the ability to initiators to define and set a range of allowable perceptions within the dimensions established for the item.

Initiators should exercise caution when setting ranges of allowable perception as too narrow a range can compromise the validity of the perceptions provided by limiting the respondent's ability to provide their true perception as well as giving away the initiator's presumed perception of the whole. This can help to ignore erroneous or disingenuous perceptions.

After a listing is developed, at step 103 the interface provide the ability to the initiator to designate that the listing is closed or open to any respondents, and set up a duration of time or quotas of submitted perception data points during which the listing remains available to potential respondents. When the listing is designated as closed, the initiator selects a target group of users, based on selected demographics, who are to access the listing and complete the survey until the duration or quota is met. For example, an invitation can be provided to any respondent that fits in a sub-group such as “females, age 21 to 25, home address within 50 miles of zip code 92101”. This would enable a population-specific perception to be collected. In certain embodiments, an initiator may choose to exclude one or more groups of certain demographics from participating in the survey.

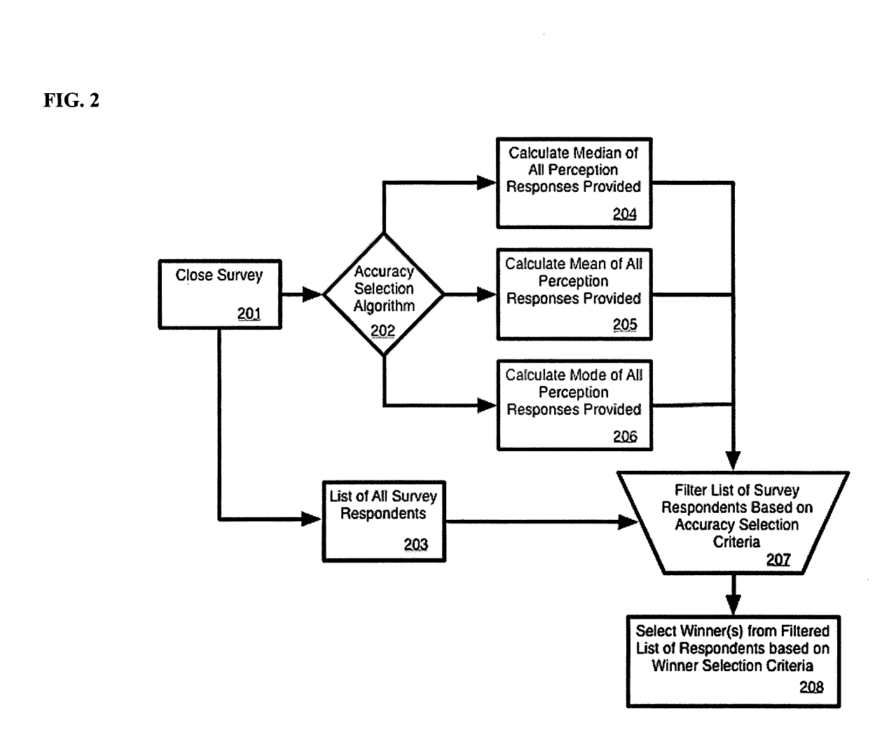

At step 104, the interface interacts with the initiator to provide an incentive and how incentive may be distributed. In a typical case, the incentive is provided in a form of monetary compensation. In certain embodiments, the incentive may be given to a winner or split equally to a set of winners. This part of the process is explained in more details in the further parts of the Detailed Description as illustrated in FIG. 2 and in the description of step 115.

At step 105, the interface interacts with the initiator to enter destination for survey results. The destination includes, for example, e-mail address, phone number, fax number, postal address, or any combination thereof. At step 106, the interface provides the initiator with the ability to securely enter payment information. Once the initiator defines the survey, selects a target group of users, determines incentive, and enters survey results destination, a survey price is calculated accordingly for the service and provided to the initiator through the interface. Once an initiator accepts the price of survey, the initiator enters pertinent payment information and authorizes the payment to process. For example, an interface interacts with the initiator allowing the initiator to select a particular form of payment (i.e., credit card, debit card, Paypal, check transfer, etc.). In certain embodiment an initiator is allowed to enter an account number that corresponds to an account or credit line that was previously established. At step 106, the initiator has the capability of returning to steps 102 through 105 to modify the requested survey parameters to produce a survey price that is acceptable to the initiator.

The survey created by the initiator is reviewed and screened for propriety and appropriateness for fielding to respondents at step 107. In certain embodiments, an automated review of the survey is conducted by comparing components of the survey with a database of prohibited words, phrases, pictures, sounds, or themes. In another embodiment, surveys are automatically provided to an individual who is responsible for reviewing propriety of the survey contents.

Once survey is approved, the listing and survey are generated and attached to an information storage repository such as a database at step 108 based on the parameters and content provided by the initiator. At this step, rules for a range of allowable perceptions within the dimensions set for the item are created and attached to the survey. These rules provide a mechanism for validating the perception data points from respondents input as they participate in a survey. In certain embodiments, errors or logical inconsistencies that are identified are reported to respondent thus enabling them to enter valid perception data point. This mechanism attempts to maximize collection of perception data points from every respondents participating in the survey and avoids discarding invalidated perception data points after the survey is closed. At step 109, an information repository such as a database is created to store survey results from respondents. In one embodiment, a storage unit is linked through an automated mechanism to each survey and is used to automatically store perception data points from respondents who participate in the survey.

At step 110, quotas of submitted perception data points or length of time the listing remains available to users are attached to the database. The automated survey mechanism then fields the survey by causing one or more listings to be launched, activated, or displayed on one or more interfaces used by users who match the target group criteria for the survey set by the initiator. For example, if the initiator specified that the target group for a particular survey would be females 18-32 years of age, then interfaces used by users associated with this target group are selected to display listings for the particular survey for participation. In certain embodiments, the automated survey mechanism scans the user accounts in a database to find target group and generate commands to place the listing on the interfaces for the users in target group using the process.

The process uses an interface to interact with new users to create user accounts in any time during the process or at step 111 when the listings are active. As previously indicated above, pertinent information about user is collected during user account creation as well as demographics that are then stored in the information repository for user account. In certain embodiments, users may set a preference in the user account to have the automated survey mechanism deliver survey invitations and/or digest of available listings to destinations set by the users. The destination includes, for example, e-mail address, phone number, fax number, postal address, or any combination thereof. In certain embodiments, users may be asked to submit information of how they want to receive incentives and whether they accept service charge for a certain delivery or payment method for their incentive, for example, to their checking account, postal address, Paypal, credit card, etc.

As previously indicated above, in certain embodiments, an automated survey mechanism that fields the surveys by causing one or more listings to be launched, activated, or displayed on one or more interfaces at step 112 that interacts with users who match the target group criteria for the surveys associated with the listings. In certain embodiment, the automated survey mechanism may also send invitation to users in target group that set a preference in the user account to receive such message. Listings for open surveys are launched, activated, or displayed on one or more interfaces that interact with all users except for the initiator that initiates the survey associated with a particular listing. In certain embodiments, users that lack certain demographic information in the user account information repository are excluded from closed survey invitations for target groups such that their interfaces do not show listings for closed surveys. A search interface can also be provided for respondent to search for listings for surveys to participate in. The search interface can show all surveys that are not targeted to a specific sub-group of users. The search interface can also filter listing results based on a user's demographics to bring up targeted surveys. The listing shows users a brief information about the survey which includes, for example, what kind of item in the survey, duration or quotas for which the survey expire, what kind of incentive being offered for winner, how winner(s) is determined, etc. At this step, a user expresses a desire to activate a listing and participate in the survey associated to the listing. Upon activation of the listing, the user interacts with the survey through an interface and provides one or more perceptions. In certain embodiments, user may choose not to participate in the survey and return to the interface showing listings. The presentation of a survey to a respondent is stimulus for the respondent to provide perception for the assessment of an item.

At step 113, and the perception data points linked with user account identifications from respondents participating in the survey are collected and stored in the information repository. At step 114, after the required number of completed surveys is obtained, or the duration for fielding the survey has expired, access to the listing for the survey is disabled. At this step, in certain embodiments, the listing is automatically removed from one or more interfaces interacting with users by an automated survey mechanism thus eliminating access to the survey by users.

After close of the survey at step 115, one or more winners are automatically determined by logic as illustrated in FIG. 2 and incentive is delivered to the user according to preference set in the user account. In certain embodiments, user is contacted through phone, postal address, fax, e-mail, or any combination thereof when the user account doesn't contain information on how incentives are delivered as expressed by the user desire.

FIG. 2 illustrates a part of the process showing, in certain embodiments, for the logic of awarding incentive to respondent(s) after the close of survey. The logic does not allow respondents with inaccurate perception data points to win the incentive. After the survey closes 201, perception data point for each respondent and associated user account identification are extracted from the information repository and sorted by perception data point into a list of all survey respondents and their perception data points 203. For a survey with a single dimension, the accuracy selection algorithm 202 determines one or more calculated values from all of the perception data points by the calculations of median 204, mean 205, mode 206, or any combination thereof. For surveys with multiple dimensions, the perception data points associated with a respondent can be treated as a vector. The accuracy selection algorithm would determine one or more calculated values from all of the perception data points or vectors by calculations of the multi-dimensional median 210 or centroid 212. The list of all survey respondents 203 is filtered by using one of the following accuracy selection criteria 207:

Multi-dimensional median 210 can be calculated using Weiszfeld's Iteration Scheme). As the iteration scheme runs, it converges to the location that minimizes the sum of the distances. Letting q₀=(q^{x}₀, q^{y}₀) denote an (arbitrary) initial location, the iteration scheme works as follows:

$${q}_{1} = \frac{1}{{Σ}_{i} 1 / ‖ {p}_{i} - {q}_{0} ‖} {\sum }_{i} \frac{{p}_{i}}{‖ {p}_{i} - {q}_{0} ‖}$$

$${q}_{2} = \frac{1}{{Σ}_{i} 1 / ‖ {p}_{i} - {q}_{1} ‖} {\sum }_{i} \frac{{p}_{i}}{‖ {p}_{i} - {q}_{1} ‖}$$

$${q}_{3} = \frac{1}{{Σ}_{i} 1 / ‖ {p}_{i} - {q}_{2} ‖} {\sum }_{i} \frac{{p}_{i}}{‖ {p}_{i} - {q}_{2} ‖}$$

$$⋮$$

$${q}_{k + 1} = \frac{1}{{Σ}_{i} 1 / ‖ {p}_{i} - {q}_{k} ‖} {\sum }_{i} \frac{{p}_{i}}{‖ {p}_{i} - {q}_{k} ‖}$$

$$⋮$$

Centroid 212 can be calculated using this formula:

$$\overline{p} = \frac{1}{n} {\sum }_{i = 1}^{n} {p}_{i}$$

A) One or more respondents with corresponding perception is selected for the filtered list using the closest match of the perception to one or more calculated values of median 204, mean 205, mode 206, multidimensional median 210, and/or centroid 212. If none of the respondents' perception is equal to the calculated scalar or vector value, respondent(s) is then selected to the next closest iteration of perception data point above and/or below the calculated value. If there is more than one respondent with corresponding perception data point that has closest match of the calculated value, all respondents with the closest match are selected for the filtered list.
B) One or more respondents with corresponding perception data point is flagged for the filtered list when the corresponding perception data falls within a given range above and below one or more calculated value of median 204, mean 205, mode 206, multidimensional median 210, and/or centroid 212. In one embodiment, the market research service provider may set a given range, preferably between 1% and 10% above and below the calculated value. This selection criterion using a given range may be useful when there are a small number of respondents.

For single dimensional surveys, if all three calculated values (median 204, mean 205, and mode 206) were used for filter respondents with either accuracy selection criteria 207, there would be more respondents on the filtered list eligible to win the incentive. For multidimensional surveys, if both the multidimensional median 210 and centroid 212 were used for filter respondents with either accuracy selection criteria 207, there would be more respondents on the filtered list eligible to win the incentive. In certain embodiments, initiator may select and refine one of the accuracy selection criteria at step 102. After all of respondents in the database are selected by the accuracy selection criteria 207 and then grouped on the filtered list, one or more winners are selected from the filtered list of respondents by one of the winner selection criteria 208:
A) A winner is randomly selected from the filtered list of respondents and the incentive will be given to the winner.
B) All respondents on the filtered list are all winners and the incentive will be split equally to each winner. Typically, this method is applicable when the incentive is a form of money that can be easily split equally and rounded off.

At step 116, the perception data points provided by users are extracted from the information repository. The extracted perception data points are processed, analyzed and formatted using common file formats as a survey report. In certain embodiments, graphical representations of the survey results are generated and inserted into the survey report. At step 117, the file containing the survey results is sent to the address using a delivery method that was previously provided by the initiator. At step 118, a receipt confirmation is received from the initiator indicating the file containing the survey results has been received.

Hardware and System

One embodiment of the invention is related to the use of a computer system for running the process and interacting with a respondent on a client computer system through a network. According to one embodiment of the invention, a survey is dynamically assigned to a respondent by a computer system in response to a processor executing one or more sequences of one or more instructions contained in main memory. Such instructions may be read into main memory from another computer-readable medium, such as storage device. Execution of the sequences of instructions contained in main memory causes processor to perform the process steps described herein. One or more processors in a multi-processing arrangement may also be employed to execute the sequences of instructions contained in main memory. In alternative embodiments, hard-wired circuitry may be used in place of or in combination with software instructions to implement the invention. Thus, embodiments of the invention are not limited to any specific combination of hardware circuitry and software.

Computer system includes a bus or other communication mechanism for communicating information, and a processor coupled with bus for processing information. Computer system also includes a main memory, such as a random access memory (RAM) or other dynamic storage device, coupled to bus for storing information and instructions to be executed by processor. Main memory also may be used for storing temporary variables or other intermediate information during execution of instructions to be executed by processor. Computer system further includes a read only memory (ROM) or other static storage device coupled to bus for storing static information and instructions for processor. A storage device, such as a magnetic disk or optical disk, is provided and coupled to bus for storing information and instructions.

Computer system may be coupled via bus to a display, such as a liquid crystal display (LCD), for displaying information to a computer user. An input device, including alphanumeric and other keys, is coupled to bus for communicating information and command selections to processor. Another type of user input device is cursor control, such as a mouse, a trackball, or cursor direction keys for communicating direction information and command selections to processor and for controlling cursor movement on display. This input device typically has two degrees of freedom in two axes, a first axis (e.g., x) and a second axis (e.g., y), that allows the device to specify positions in a plane.

The term “computer-readable medium” as used herein refers to any medium that participates in providing instructions to processor for execution. Such a medium may take many forms, including but not limited to, non-volatile media, volatile media, and transmission media. Non-volatile media includes, for example, optical or magnetic disks, such as storage device. Volatile media includes dynamic memory, such as main memory. Transmission media includes coaxial cables, copper wire and fiber optics, including the wires that comprise bus. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor for execution. For example, the instructions may initially be carried on a magnetic disk of a remote computer. The remote computer can load the instructions into its dynamic memory and send the instructions over a telephone line using a modem. A modem local to computer system can receive the data on the telephone line and use an infrared transmitter to convert the data to an infrared signal. An infrared detector coupled to bus can receive the data carried in the infrared signal and place the data on bus. Bus carries the data to main memory, from which processor retrieves and executes the instructions. The instructions received by main memory may optionally be stored on storage device either before or after execution by processor.

Computer system also includes a communication interface coupled to the bus. Communication interface provides a two-way data communication coupling to a network link that is connected to a local network. For example, communication interface may be an integrated services digital network (ISDN) card or a modem to provide a data communication connection to a corresponding type of telephone line. As another example, communication interface may be a local area network (LAN) card to provide a data communication connection to a compatible LAN. Wireless links may also be implemented. In any such implementation, communication interface sends and receives electrical, electromagnetic or optical signals that carry digital data streams representing various types of information.

Network link typically provides data communication through one or more networks to other data devices. For example, network link may provide a connection through local area network to a server or to data equipment operated by an Internet Service Provider (ISP). ISP in turn provides data communication services through the worldwide packet data communication network now commonly referred to as the “Internet”. Local network and Internet both use electrical, electromagnetic or optical signals that carry digital data streams. The signals through the various networks and the signals on network link and through communication interface, which carry the digital data to and from computer system, are exemplary forms of carrier waves transporting the information.

Computer system can send messages and receive data, including program code, through the network(s), network link and communication interface. In the Internet example, a server might transmit a requested code for an application program through Internet, ISP, local network and communication interface. In accordance with the invention, one such application provides for running the process as described herein.

The received code may be executed by processor as it is received, and/or stored in storage device, or other non-volatile storage for later execution. In this manner, computer system may obtain application code in the form of a carrier wave.

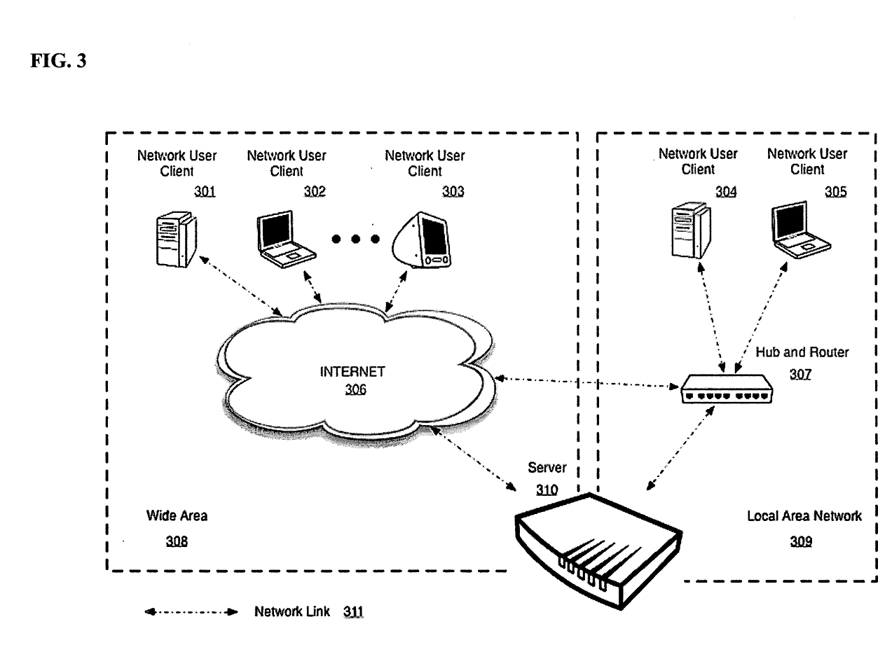

FIG. 3 illustrates in block form an example of the parties and systems involved in this context. In FIG. 3, a user is coupled either directly or indirectly to the Internet 306. For example, a user may be connected to Internet 306 through a local area network 309, an Internet Service Provider, an Online Service Provider such as AOL, a proprietary server, or any combination thereof. The users referenced in this description are end station devices such as a personal computer, workstation, network computer, etc. In the preferred embodiment, the client and other clients have a processor that executes an operating system and a browser program under control of the operating system. The browser program is an industry-standard World Wide Web browser, such as, for example, Microsoft Internet Explorer, Netscape Navigator, or NCSA Mosaic.

Connected to the Internet 306 is a plurality of network user clients 301, 302, 303, 304 and 305. By interfacing with network user clients 301, 302, 303, 304 and 305, network users can access, display and interact with Web pages that are contained on servers that are coupled to Internet 306 such as the survey process server 310.

Through Internet 318 or locally through a network hub 307, network user clients 301, 302, 303, 304 and 305 can connect to the server 310. Preferably, network user clients 301, 302, 303, 304 and 305 communicate with the survey process server 310 using industry-standard protocols such as Transmission Control Protocol (TCP), Internet Protocol (IP), and Hypertext Transfer Protocol (HTTP).

The survey process server 310 run and manages the process described herein and contains storage unit. The survey process server 310 contains interface data that defines an interface that can be used to create a survey. For example, if an initiator requests to define a survey, the survey process server 310 automatically sends interface data over Internet 306 to cause an interface to be displayed on the browser executing on one of the user clients belonging to the initiator. The initiator then interacts with the interface to create a survey. The survey process server 310 also uses the interface interacts with user clients who are respondents. Storage unit on the survey process server 310 is used to store survey results. As network users participate in the surveys, the results are automatically stored in the storage unit on the survey process server 310. In certain embodiment, a person from a market research service provider that manages the survey process server 310 may interacts with the administrative interface of the survey process server 310 for tasks related to a part of the process described herein such as, for example, screening the survey for propriety for fielding to users, printing and mailing the survey results, etc.

Alternatives, Extensions

In describing certain embodiments of the invention, several drawing figures have been used for explanation purposes. However, the invention is not limited to any particular configuration. The invention includes other contexts and applications in which the mechanisms and processes described herein are available to other mechanisms, methods, programs, and processes. Thus, the specification and drawings are, accordingly, to be regarded in an illustrative rather than a restrictive sense.

Although FIG. 3 depicts a single server 310 running the process, embodiments of the invention are not limited to any particular number of servers running the process. In addition, although server 310 running the process is depicted as a single component, it may actually consist of multiple computing and/or storage units that are configured to perform the functions described herein.

In addition, in this disclosure, certain process steps are set forth in a particular order, and alphabetic and alphanumeric labels are used to identify certain steps. Unless specifically stated in the disclosure, embodiments of the invention are not limited to any particular order of carrying out such steps. In particular, the labels are used merely for convenient identification of steps, and are not intended to imply, specify or require a particular order of carrying out such steps.

What is claimed is

1. A method for collecting perception assessment with incentive offers during an event having a plurality of respondents, comprising:
presenting stimuli to said respondents of said event;
collecting perception data points to said stimuli;
aggregating set of said perception data points by a mathematic assessment into a summary value;
determining one or more eligible respondents to receive incentive; and,
awarding one or more said eligible respondents with said incentive.

2. The method of claim 1 wherein said respondents volunteer or are invited to said event.

3. The method of claim 1 wherein said mathematic assessment comprises calculating a summary value from mean, median, mode, multidimensional median, or centroid for set of said respondent data points.

4. The method of claim 1 wherein said step of collecting respondent data points comprises setting a range of allowable perception data points.

5. The method of claim 1 wherein the step of awarding comprises splitting said incentive to said eligible respondents.

6. The method of claim 1 wherein the step of awarding comprises rewarding randomly selected one or more said eligible respondents.

7. The method of claim 1 wherein the step of determining comprises matching said respondents most closely to said summary value.

8. The method of claim 1 further comprising disallowing duplicate feedback from said respondents.

9. The method of claim 1 wherein said incentive comprises tangible benefit offered for participation in said event.

10. The method of claim 1 wherein said incentive comprises non-tangible benefit offered for participation in said event.

11. The method of claim 1 wherein said stimuli refers to any tangible or non-tangible object or set of objects.

12. The method of claim 11 wherein said object is commodity, goods, service, or combination thereof.

13. The method of claim 1 wherein the step of presenting comprises displaying stimuli through any combination of physical, textual, visual, auditory, or electronic means.

14. The system of collective perception assessment with incentive offer, the system comprising:
a memory;
one or more processors coupled to the memory; and,
a set of computer instructions contained in the memory, the set of computer instructions including computer instruction which when executed by the one or more processors, cause the one or more processor to perform the steps of:
presenting stimuli to said respondents of said event;
collecting perception data points to said stimuli;
aggregating set of said perception data points by a mathematic assessment into a summary value;
determining one or more eligible respondents to receive incentive; and,
awarding one or more said eligible respondents with said incentive.

15. The system of claim 14 further comprising disallowing duplicate feedback from said respondents.

16. A system for collecting perception assessment with incentive offers during an event having a plurality of respondents, comprising:
means for presenting stimuli to said respondents of said event;
means for collecting perception data points to said stimuli;
means for aggregating set of said perception data points by a mathematic assessment into a summary value;
means for determining one or more eligible respondents to receive incentive; and,
means for awarding one or more said eligible respondents with said incentive.

17. The system of claim 16 further comprising means for means for inviting said respondents to said event.

18. The system of claim 16 wherein said mathematic assessment comprises means for calculating a summary value from mean, median, mode, multidimensional median, or centroid for set of said respondent data points.

19. The system of claim 16 wherein said means for collecting respondent data points comprises means for setting a range of allowable perception data points.

20. The system of claim 16 wherein means for awarding comprises means for splitting said incentive to said eligible respondents.
